(19) United States
(12) Patent Application Publication
(10) Pub. No.: US 2007/0036051 A1
(43) Pub. Date: Feb. 15, 2007

(54) Disc drive apparatus

(75) Inventor: Victor Martinus Gerardus Van Acht, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke phillips electronics n.v.

(21) Appl. No.: 10/569,181

(22) PCT Filed: Aug. 18, 2004
(86) PCT No.: PCT/IB04/51482

§ 371 Date: Feb. 22, 2006

(30) Foreign Application Priority Data
Sep. 3, 2003 (EP) 03103271.7

(51) Int. Cl. G11B 20/10

(52) U.S. Cl. 369/47.28

(57) ABSTRACT

A disc drive apparatus (1), for writing/reading information to/from an optical storage disc (2), comprises: means (4) for rotating the disc (2) at a variable disc rotation speed; an optical system (30) for generating a scan beam (32); an actuator system (50) for positioning a focus point (F) of the scan beam (32); and a control circuit (90) for controlling the actuator system (50). The control circuit (90) comprises a learning feed forward block (110) comprising a memory bank (130) having N memory locations (M(1) . . . (M(N)) and further comprises a digital reconstruction filter (150). The memory bank (130) is operated by a first clock signal (CLK1) at a first clock frequency (φ1), and the digital reconstruction filter (150) is operated by a second clock signal (CLK2) at a second clock frequency (φ2) having a fixed ratio to the first clock frequency (φ1).

The present invention relates in general to a disc drive apparatus for writing/reading information into/from an optical storage disc; hereinafter, such disc drive apparatus will also be indicated as “optical disc drive”.

The present invention relates particularly to an optical disc drive for handling CD or DVD discs, and the invention will be specifically explained for such application. However, it is noted that this is not to be understood as limiting the use of the present invention, as the present invention is useful for other types of disc as well.

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writeable type, where information may be stored by a user. For writing information in the storage space of the optical storage disc, or for reading information from the disc, an optical disc drive comprises, on the one hand, rotating means for receiving and rotating an optical disc, and on the other hand an optical system for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

Said optical scanning system comprises a light beam generator device (typically a laser diode), an objective lens for focusing the light beam in a focal spot on the disc, and an optical detector for receiving the reflected light reflected from the disc and for generating an electrical detector output signal.

During operation, the light beam should remain focused on the disc. To this end, the objective lens is arranged axially displaceable, and the optical disc drive comprises focal actuator means for controlling the axial position of the objective lens. From said detector output signal, a focal error signal can be derived, indicating a focal error, i.e. a measure of the error in the axial position of the objective lens, i.e. the distance between the actual axial position of the objective lens and the desired axial position of the objective lens.

Further, the focal spot should remain aligned with a track or should be capable of being positioned with respect to a new track. To this end, at least the objective lens is mounted radially displaceable, and the optical disc drive comprises radial actuator means for controlling the radial position of the objective lens. From said detector output signal, a radial error signal can be derived, indicating a radial error, i.e. a measure of the error in the radial position of the focal spot, i.e. the distance between the center of the focal spot and the center of the track.

An important source for tracking errors and focal errors is the shape of the disc. For instance, tracking errors are mainly due to eccentricity of the disc. This means that, during rotation of the disc, tracking errors and focal errors will show a repetitive behavior, with a repetition period of one revolution. Therefore, these errors can be predicted, or “learned”, on the basis of experience.

To this end, learning feed forward control circuitry for tracking control and focus control has been developed, comprising a memory loop having a predetermined number of memory locations, each corresponding to a certain disc segment; in a typical example, this memory loop has 64 memory locations. This memory loop is operated as a shift register. During operation, when reading/writing is performed in respect of a certain disc segment, the tracking error is measured and stored as error data in the first memory location. As rotation of the disc continues, this error data is shifted one location each time the laser beam enters another disc segment. After one full revolution, this error data is back at the first memory location, and can be read to estimate the tracking error even before the laser beam actually enters the corresponding disc segment, so that error correction can take place before errors actually happen.

Thus, the error correction circuitry receives, from the memory loop, estimated correction data, which is constant during the scanning of one disc segment, and which changes at the transition from one segment to the next. In order to prevent undesired tracking control behavior due to stepwise change of the estimated correction data, the error correction circuitry comprises a digital low-pass filter in the output of the memory loop, which filter is also termed a “reconstruction filter”.

A problem in this respect is the fact that such filter introduces a delay. This delay is compensated by reading the memory locations in advance, i.e. the estimated correction data which the filter now at its input receives from the memory loop corresponds to a disc segment which is reached by the laser beam after a short time in the future. A read advance number can be defined as the number of memory locations between the memory location being read and the memory location corresponding to the current disc segment.

In the prior art the delay caused by the reconstruction filter is substantially constant, depending mainly on the clock frequency of the digital filter, which is substantially constant in the prior art. On the other hand, the read advance number corresponds to the number of disc segments along a track length traveled by the laser beam during said delay. This number is not constant during operation: it depends on the rotational speed of the disc. Therefore, it is constantly necessary to compute the current value of the read advance number, and to adjust the memory loop accordingly. This requires complicated calculation circuitry and/or software.

For instance, assume that the delay time caused by the filter is 0.005 s. In the case of a disc divided into 64 segments and being played at a constant angular velocity of 1 Hz, the read advance number would be approximately 1, whereas the read advance number would be approximately 32 if this disc would be played at a constant angular velocity of 100 Hz.

Same problems exist for the case of focal error control.

It is a general objective of the present invention to eliminate or at least reduce these problems.

Specifically, the present invention aims to provide a method and device in which the read advance number is constant.

According to an important aspect of the invention, instead of being fixed, the clock frequency of the digital reconstruction filter has a fixed ratio to the disc rotational frequency. As a consequence, at higher disc rotational frequency, the filter operates faster such that its delay would be shorter. Particularly, expressed in time, the delay of the digital reconstruction filter varies with the disc rotational frequency, but expressed in number of disc segments, the delay of the digital reconstruction filter is constant. Thus, the read advance number is constant, and the complicated computation of the read advance number can be omitted.

These and other aspects, features and advantages of the present invention will be further explained by the following description with reference to the drawings, in which same reference numerals indicate same or similar parts, and in which:

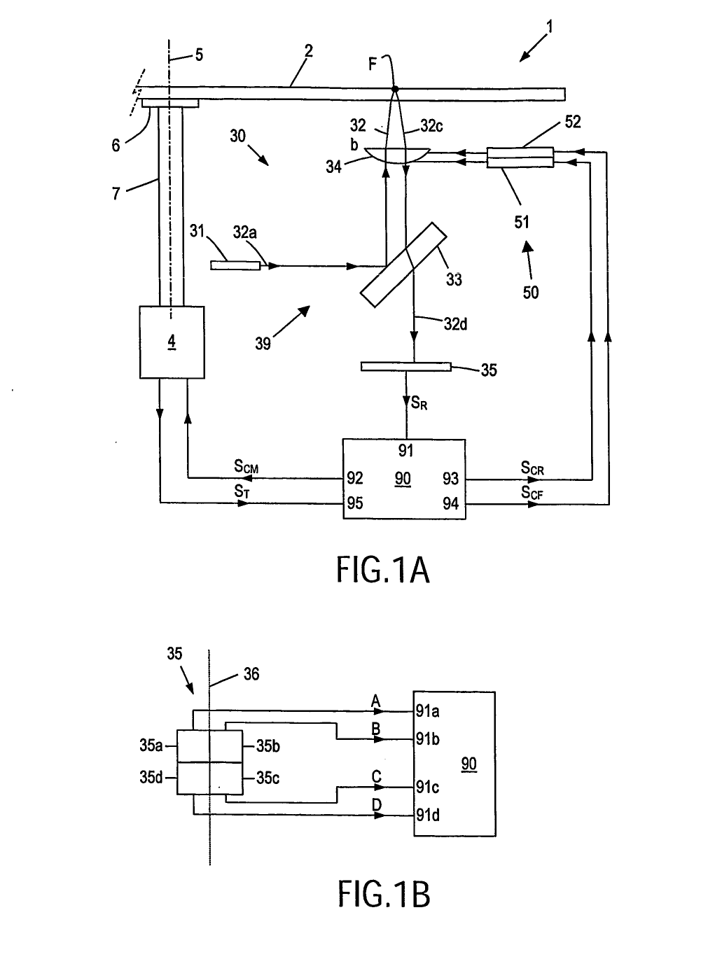

FIG. 1A schematically illustrates relevant components of an optical disc drive apparatus;

FIG. 1B schematically illustrates details of an optical detector;

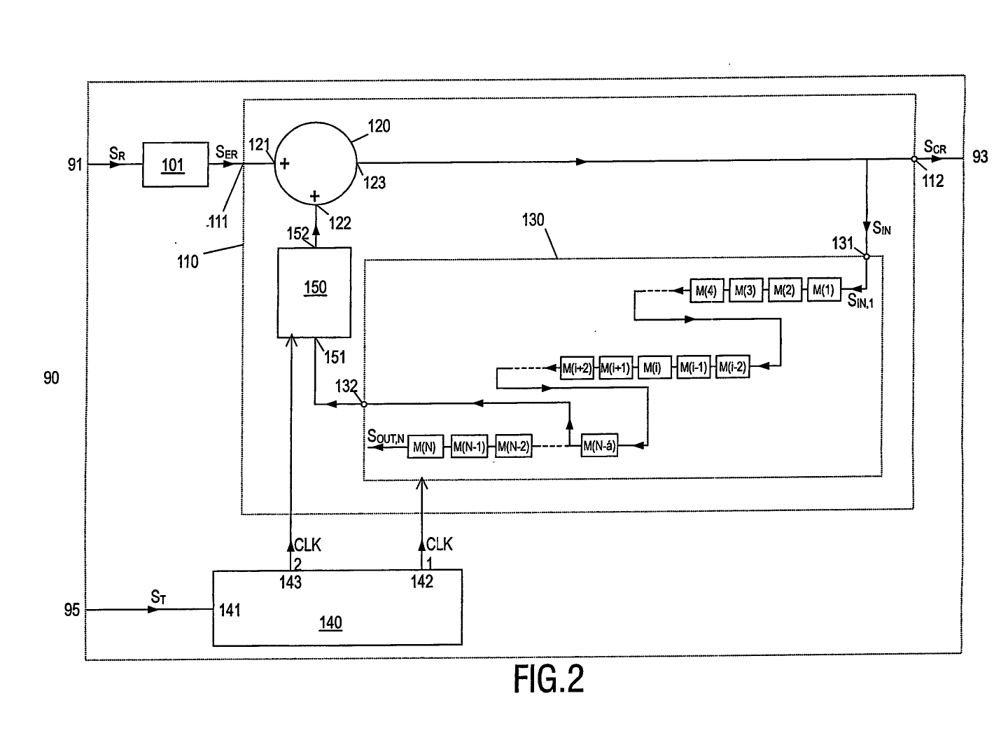

FIG. 2 is a block diagram schematically illustrating relevant components of a controller;

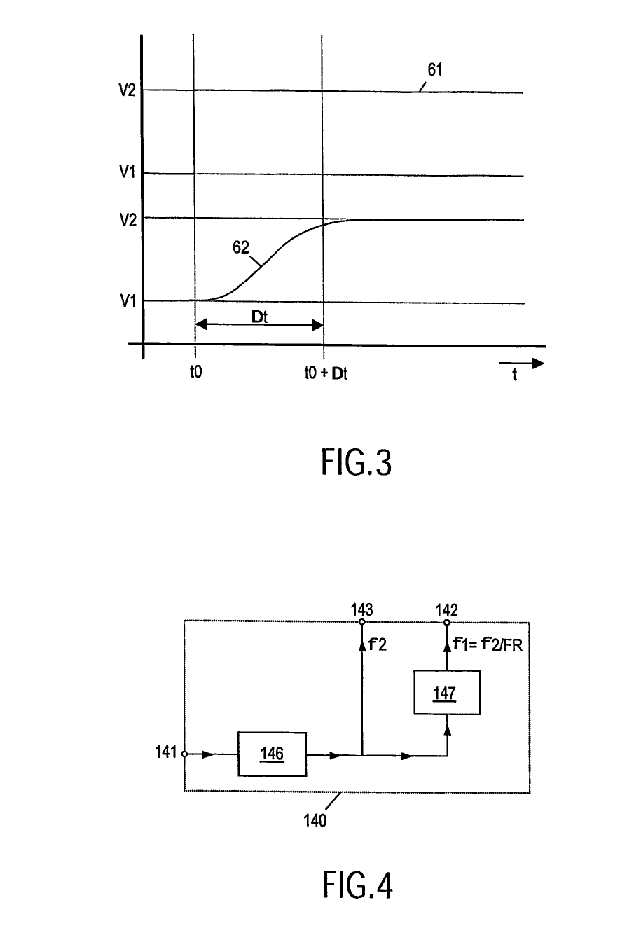

FIG. 3 is a graph illustrating the step response of the reconstruction filter;

FIG. 4 is a block diagram illustrating a preferred embodiment of a clock generator.

FIG. 1A schematically illustrates an optical disc drive apparatus 1, suitable for storing information on or reading information from an optical disc 2, typically a DVD or a CD. For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1A, the optical system 30 comprises a light beam generating means 31, typically a laser such as a laser diode, arranged to generate a light beam 32. In the following, different sections of the light beam 32 will be indicated by a character a, b, c, etc added to the reference numeral 32.

The light beam 32 passes a beam splitter 33 and an objective lens 34 to reach (beam 32b) the disc 2. The light beam 32b reflects from the disc 2 (reflected light beam 32c) and passes the objective lens 34 and the beam splitter 33 (beam 32d) to reach an optical detector 35. The objective lens 34 is designed to focus the light beam 32b in a focal spot F on a recording layer (not shown for sake of simplicity) of the disc.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since axial actuators are known per se, while further the design and operation of such axial actuator is no subject of the present invention, it is not necessary here to discuss the design and operation of such focal actuator in great detail.

It is further noted that means for supporting the objective lens with respect to an apparatus frame, and means for axially and radially displacing the objective lens, are generally known per se. Since the design and operation of such supporting and displacing means are no subject of the present invention, it is not necessary here to discuss their design and operation in great detail.

It is further noted that the radial actuator 51 and focal actuator 52 may be implemented as one integrated actuator.

The disc drive apparatus 1 further comprises a control circuit 90 having a first output 92 connected to a control input of the motor 4, having a second output 93 coupled to a control input of the radial actuator 51, and having a third output 94 coupled to a control input of the focal actuator 52. The control circuit 90 is designed to generate at its first output 92 a control signal S_{CM} for controlling the motor 4, to generate at its second control output 93 a control signal S_{CR} for controlling the radial actuator 51, and to generate at its third output 94 a control signal S_{CF} for controlling the focal actuator 52.

The control circuit 90 further has a read signal input 91 for receiving a read signal S_{R} from the optical detector 35.

FIG. 1B illustrates that the optical detector 35 comprises a plurality of detector segments, in this case four detector segments 35a, 35b, 35c, 35d, capable of providing individual detector signals A, B, C, D, respectively, indicating the amount of light incident on each of the four detector quadrants, respectively. A center line 36, separating the first and fourth segments 35a and 35d from the second and third segments 35b and 35c, has a direction corresponding to the track direction. Since such four-quadrant detector is commonly known per se, it is not necessary here to give a more detailed description of its design and functioning.

FIG. 1B also illustrates that the read signal input 91 of the control circuit 90 actually comprises four inputs 91a, 91b, 91c, 91d, for receiving said individual detector signals A, B, C, D, respectively. The control circuit 90 is designed to process said individual detector signals A, B, C, D, in order to derive data and control information therefrom, as will be clear to a person skilled in the art.

For instance, a data signal S_{D} can be obtained by summation of all individual detector signals A, B, C, D according to
S_{D}=A+B+C+D (1)
Further, a tracking error signal S_{ER} can be derived, for instance a push-pull tracking error signal according to

$${S}_{ER} = \frac{( A + D ) - ( B + C )}{A + B + C + D} \qquad ( 2 )$$

Further, a focal error signal S_{EF} can be derived, for instance, in the case of astigmatic focusing, according to

$${S}_{EF} = \frac{B - A}{LPF ( B + A )} - \frac{C - D}{LPF ( C + D )} \qquad ( 3 )$$

wherein the function LPF(x) indicates a low-pass filtering of the signal x. It is noted, however, that suitable error signals may be defined according to different formulas.

In the following, the invention will be explained specifically for the tracking control, but it is to be understood that the invention likewise applies to focus control.

FIG. 2 is a block diagram schematically illustrating part of the controller 90, relating to tracking control. The detector signal S_{R} from the detector 35 is received at input 91. A tracking error processing block 101 processes the detector signal S_{R} to calculate a current tracking error signal S_{ER}, for instance in accordance with formula (2). The current tracking error signal S_{ER} is received at an input 111 of an LFF (learning feed forward) block 110. The LFF 110 comprises an adder 120, having a first input 121 coupled to the LFF input 111, and a shift memory bank 130, comprising N memory locations M(1)-M(N). Each memory location M(i) has in input coupled to a previous neighboring memory location M(i−1) and an output coupled to a next neighboring memory location M(i+1). The first memory location M(1) has its input coupled to an output 123 of the adder 120.

The controller 90 has a second input 95 receiving a tacho signal S_{T} indicating the rotational speed of the motor 4. This tacho signal may be generated by any suitable tacho generator, as will be clear to a person skilled in the art, so it is not necessary to describe details of design and operation of a tacho generator in greater detail. It is noted that it is also possible that the controller 90 uses its own motor control signal S_{CM} as tacho signal.

The controller 90 further comprises a clock generator 140, having an input 141 coupled to the second input 95 to receive the tacho signal S_{T}. The clock generator 140 is designed to generate at a first clock output 142 a first clock signal CLK1 for the memory bank 130. Timed by the first clock signal CLK1, memory transfer steps are performed at memory transfer moments, wherein each memory location M(i) gives its contents to its next neighboring memory location M(i+1) and takes the contents from the previous neighboring memory location M(i−1), and wherein the first memory location M(1) takes the output from the adder 120. The timing is such that the memory transfer steps are performed after each 1/N-th part of a 360° revolution of the disc 2, such that the output signal from adder 120 appears at the output of the last memory location M(N) after one full disc revolution. The memory bank 130 has an output 132, coupled to the second input 122 of the adder 120. At its output 132, the memory bank 130 provides the contents of one of the memory locations as will be explained later. Due to the memory transfer steps, the output signal from the memory bank 130 provided at its output 132 contains stepwise changes.

The output signal from the adder 120 is also coupled to the first controller output 93, for providing the tracking control signal S_{CR}. In order to prevent stepwise changes of the tracking control signal S_{CR} at the memory transfer moments, a low-pass reconstruction filter 150 is coupled between the output 132 of the memory bank 130 and the second input 122 of the adder 120. This reconstruction filter 150 is a digital filter, clocked by a second clock signal CLK 2 generated by the clock generator 140 and provided at a second output 143 thereof.

FIG. 3 is a graph illustrating the step response of the reconstruction filter 150, showing that the reconstruction filter 150 causes a delay Δt. The horizontal axis of FIG. 3 represents time, the vertical axis represent signal magnitude (in arbitrary units). Assume that at a memory transfer moment t0, the signal magnitude at input 151 of the reconstruction filter 150 changes stepwise from a first signal value V1 to a second signal value V2, as illustrated by a first line 61. Due to the low-pass frequency characteristic of the reconstruction filter 150, the output signal provided at output 152 of the reconstruction filter 150 can not follow this step, but starts to rise from value V1 at time t=t0, and approaches the second signal value V2 only at time t=t0+Δt, i.e. after a delay time Δt, as illustrated by a second line 62.

In this respect, it is noted that the value of the delay time may be defined as the time needed for the output signal to bridge a predefined percentage of the step (V2-V1), for instance 90%.

In order to compensate for the delay time At, i.e. to assure that the adder 120 receives a substantially correct error prediction signal at its second input 122 at substantially the correct moment, i.e. t0 in this example, the output 132 of the memory bank 130 is not coupled to the output of the last memory location M(N), but to the output of a memory location M(N−α), i.e. a memory locations before the last memory location M(N).

Generally speaking, the functioning of the LFF 110 can be considered as being prior art, and will therefore be discussed only briefly. The memory bank 130 can be considered as a delay line, feeding back a control signal supplied to the actuator in one disc segment as a prediction for use one disc revolution later. The memory bank or delay line 130 is clocked such that the rotational speed of the disc is matched.

In prior art, the clocking of the reconstruction filter 150 is constant, so that the delay time Δt is substantially constant, as expressed in time units. This means that, in prior art, the value of a needs to be adapted to the actual rotational speed of the disc.

According to the present invention, however, the delay time Δt is variable, as expressed in time units. The operation of the reconstruction filter 150 is controlled such that the delay time Δt is adapted to the actual rotational speed of the disc, such that a is constant. Thus, the output 132 of the memory bank 130 can be fixedly coupled to the output of a predetermined memory location M(N−α), as illustrated in FIG. 2. This avoids the need for complicated circuitry and/or software for calculating a on the basis of the actual rotational speed of the disc, and for coupling the input 151 of the reconstruction filter 150 to the output of a calculated memory location M(N−α).

According to an important aspect of the present invention, the memory bank 130 is clocked with a first clock signal CLK1 having a first clock frequency φ1, and the reconstruction filter 150 is clocked with a second clock signal CLK2 having a second clock frequency φ2, wherein the frequency ratio FR between first clock frequency φ1 and second clock frequency φ2 is fixed.

FIG. 4 is a block diagram illustrating a preferred embodiment of the clock generator 140, comprising a PLL circuit 146 and a divider circuit 147. The PLL circuit 146 has its input coupled to the input 141 of clock generator 140, thus receiving the tacho signal S_{T} from the motor 4, and is adapted to generate an output signal having a fixed ratio with respect to its input signal. In the embodiment shown, the output signal from the PLL circuit 146 has the second clock frequency φ2, and the output of the PLL circuit is coupled directly to the second output 143 of the clock generator 140 to provide the second clock signal CLK2. The divider circuit 147 has its input coupled to the output of the PLL circuit, and has its output coupled to the first output 142 of the clock generator 140 to provide the first clock signal CLK1. The divider circuit 147 is set to provide the required fixed ratio FR between first clock frequency φ1 and second clock frequency φ2.

It should be clear to a person skilled in the art that the present invention is not limited to the exemplary embodiments discussed above, but that several variations and modifications are possible within the protective scope of the invention as defined in the appending claims.

For instance, the topology of the blocks shown in FIG. 2 and discussed in the above may be different, depending on the implementation design.

Since the memory locations M(N−α+) to M(N) of the memory bank 130 are not used in the exemplary embodiment as discussed in the above, they may be omitted, in which case the input 151 of the reconstruction filter 150 would be fixedly connected to the output of the last memory location. However, since the memory bank 130 is clocked every 1/N-th part of a disc revolution, the full length of the memory bank does not correspond to one full disc revolution in this case.

On the other hand, in order to avoid or at least reduce possible noise problems, it is possible that the input of the first memory location M(1), instead of only receiving the signal which is received at input 131 of the memory bank 130, receives a weighted combination of this input signal and the output signal of the last memory location M(N). In such a case, which is not shown in FIG. 2, all memory locations M(1) to M(N) are used. As an example of a suitable weighted combination of input signal received at input 131 (indicated hereinafter as S_{N}) and output signal of last memory location M(N) (indicated hereinafter as S_{OUT,N}), the input signal to the first memory location M(1) (indicated hereinafter as S_{IN,1}) may be calculated as S_{IN,1}+0.95*S_{OUT,N}=0.05*S_{N}.

In the above-discussed exemplary embodiment, the signal received at input 131 of the memory bank 130 is the output signal from the learning feed forward block 110. In an alternative embodiment, the input 131 of the memory bank 130 may also receive the input signal S_{ER} received at input 111 of the learning feed forward block 110. An advantage of such design may be an increased stability.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Disc drive apparatus (1), for writing/reading information to/from an optical storage disc (2), comprising:
means (4) for rotating the disc (2) at a variable disc rotation speed;
an optical system (30) for generating a scan beam (32) for scanning a track of the disc;
an actuator system (50) for positioning a focus point (F) of the scan beam (32);
a control circuit (90) for controlling the actuator system (50);
wherein the control circuit (90) comprises a learning feed forward block (110) comprising a memory bank (130) having N memory locations (M(1) . . . (M(N)) and further comprising a digital reconstruction filter (150);
wherein the memory bank (130) is operated by a first clock signal (CLK1) at a first clock frequency (φ1) proportional to the disc rotation speed;
and wherein the digital reconstruction filter (150) is operated by a second clock signal (CLK2) at a second clock frequency (φ2) having a fixed ratio (FR) to the first clock frequency (φ1).

2. Disc drive apparatus (1) according to claim 1, further comprising:
an optical detector (35) for receiving a reflected beam (32d);
wherein the control circuit (90) comprises an error processing block (101) for receiving a detector output signal (S_{R}) from the optical detector (35), and for calculating an error signal (S_{ER});
the learning feed forward block (110) having an input (111) coupled for receiving the error signal (S_{ER}) from the error processing block (101);
the memory bank (130) having an output (132);
the digital reconstruction filter (150) having an input (151) coupled to the output (132) of the memory bank (130) and having an output (152);
the learning feed forward block (110) further comprising an adder (120), having a first input (121) coupled to said input (111) of the learning feed forward block (110), having a second input (122) coupled to the output (152) of the reconstruction filter (150), and having an output (123) coupled to an output (112) of the learning feed forward block (110).

3. Disc drive apparatus (1) according to claim 2, wherein the memory bank (130) has an input (131) coupled to the output (112) of the learning feed forward block (110).

4. Disc drive apparatus (1) according to claim 2, wherein the memory bank (130) has an input (131) coupled to the input (111) of the learning feed forward block (110).

5. Disc drive apparatus (1) according to claim 1, wherein the memory bank (130) has an input (131) receiving a bank input signal (S_{IN}), and wherein the input signal (S_{IN,1}) to the first memory location (M(1)) is a weighted combination of said bank input signal (S_{IN}) and the output signal (S_{OUT,N}) of the last memory location (M(N)).

6. Disc drive apparatus (1) according to claim 1, wherein the digital reconstruction filter (150) has an input (151) fixedly coupled to the output of a predetermined memory location (M(N−α)) of the memory bank (130).

7. Disc drive apparatus (1) according to claim 1, wherein the control circuit (90) has a second input (95) coupled to receive a tacho signal (S_{T}) representing the rotational speed of the disc (2), and wherein the second clock signal (CLK2) of the digital reconstruction filter (150) has a fixed ratio to the disc rotational speed.

8. Disc drive apparatus (1) according to claim 1, wherein the control circuit (90) further comprises a clock generator circuit (140) having an input (141) coupled to receive a tacho signal (S_{T}) representing the rotational speed of the disc (2), and wherein the clock generator circuit (140) is adapted to generate the first clock signal (CLK1) and the second clock signal (CLK2) on the basis of the tacho signal (S_{T}).

9. Disc drive apparatus (1) according to claim 8, wherein the clock generator circuit (140) comprises first generator means (146) for generating one of said clock signals (CLK2; CLK1) and second generator means (147) receiving this one clock signal (CLK2; CLK1) and being adapted to generate the other of said clock signals (CLK1; CLK2) from said one clock signal (CLK2; CLK1).

10. Disc drive apparatus (1) according to claim 9, wherein the first generator means (146) is adapted for generating the second clock signal (CLK2) for the reconstruction filter (150), and wherein the second generator means (147) comprise a divider (147) for generating the first clock signal (CLK1) for the memory bank (130).

11. Disc drive apparatus (1) according to claim 1, wherein the actuator system (50) comprises a radial actuator (51) for radially displacing the objective lens (34) with respect to the disc (2);
wherein the control circuit (90) comprises a control output (93) coupled to a control input of the radial actuator (51);
and wherein the control circuit (90) is designed to use an output signal of the learning feed forward block (110) for generating at its control output (93) a control signal (S_{CR}) for controlling the radial actuator (51).

12. Disc drive apparatus (1) according to claim 1, wherein the actuator system (50) comprises a focal actuator (52) for axially displacing the objective lens (34) with respect to the disc (2);
wherein the control circuit (90) comprises a control output (94) coupled to a control input of the focal actuator (52);
and wherein the control circuit (90) is designed to use an output signal of the learning feed forward block (110) for generating at its control output (94) a control signal (S_{CF}) for controlling the focal actuator (52).
